(19) United States
(12) Patent Application Publication
(10) Pub. No.: US 2019/0306020 A1
(43) Pub. Date: Oct. 3, 2019

(54) SYSTEM FOR CONFIGURING A NETWORK DEVICE USING NEAR-FIELD COMMUNICATION/BLUETOOTH LOW ENERGY COMMUNICATION

(71) Applicant: Transition Networks, Inc., Minnetonka, MN (US)

(72) Inventors: David J. Corbett, Eagan, MN (US); Anita Kumar, Edina, MN (US); GlenNiece Kutsch, Chaska, MN (US); Jeffrey D. Mullin, Elk River, MN (US)

(21) Appl. No.: 16/371,584

(22) Filed: Apr. 1, 2019

Related U.S. Application Data
(60) Provisional application No. 62/651,208, filed on Apr. 1, 2018.

(51) Int. Cl. H04L 12/24; H04W 4/80; H04L 12/10

(52) U.S. Cl. CPC H04L 41/0806; H04L 41/22; H04W 84/18; H04L 12/10; H04W 4/80

(57) ABSTRACT

Disclosed end-user devices include a processing unit and transceiver circuitry configured to communicate wirelessly with corresponding transceiver circuitry of a network device. Memory of the end-user device stores network device configuration data and instructions to configure the network device, and stores a network device configuration application executable by the processing unit to facilitate configuring the network device by wirelessly transmitting the network device configuration data and instructions to the network device using the transceiver circuitry. The network device configuration application also configures the end-user device to monitor and diagnose the network device through a communications channel established by the transceiver circuitry of the end-user device and the transceiver circuitry of the network device.

### CROSS-REFERENCE TO RELATED APPLICATION

This application claims the benefit of U.S. Provisional Application No. 62/651,208, which was filed on Apr. 1, 2018

### BACKGROUND OF THE INVENTION

The present invention relates to systems for configuring network devices. Specifically, the present invention relates to configuring network devices using near-field communications and other types of wireless communications such as low-power wireless communications.

Near-field communication (NFC) is a set of communication protocols that enable two electronic devices to establish communication by bringing them within close distance of each other. NFC is often used for contactless payment systems, social networking, and sharing contacts, photos, or videos. Also, NFC-enabled devices can act as electronic identity devices. NFC offers a low-speed connection that can be used to bootstrap more robust wireless connections. This last-mentioned feature can be especially useful in the configuration of Wi-Fi networks. For instance, NFC can be used to share MAC Addresses and IP Addresses and then more robust communication systems can be used once such initial configurations are made. The advantage of using a more robust wireless technology is that it permits faster data transfers than NFC. But, where the data transfers are minimal in size, NFC can be advantageous since less power is required to implement the transfers. Bluetooth Low Energy (BLE) is a lower power variant of Bluetooth personal area network (PAN) technology, which uses frequency hopping wireless technology in the 2.4 GHz unlicensed radio band to interconnect nearby devices. BLE facilitates infrequent short-range wireless data communication between devices, while utilizing very little power (e.g., 0.01 to 0.5 watts).

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The system and operations described herein can configure a network device (such as a switch) using at least NFC. Embodiments can include a mobile application to configure (such as preconfigure), diagnose and manage network devices via NFC and low-power wireless communication such as Bluetooth Low Energy (BLE) communication.

Installation of security and surveillance equipment is often challenging as many network devices are deployed at a time and network devices and cameras are often installed in inaccessible or hard to access locations such as light poles, walls or in locked cabinets. The disclosed technologies can provide installers a solution for ease of configuration prior to deployment and ease of access diagnostics and configuration after deployment.

The unique solutions described herein include a mobile application capable of running on smart phones and tablets. The mobile device and application can provide access to the network device (e.g., switch) via NFC and low-energy communications (such as BLE). The respective hardware on the network device is connected to a processing unit and network device chip and supporting software running on the network device.

One of the benefits of the system is that a user can download the end-user mobile application from an online application store or from a website of the service provider. Also, the application can work across different mobile operating systems.

Pre-configuration of the network device (e.g., switch) is available via the NFC interface of the network device. A mobile application option “Initialize” allows the user to create or import configuration file(s) which can set key user configurations such as IP address, System Name, Location etc. E.g., see FIGS. 3 and 4. The user can then position the mobile device over the NFC antenna in the network device and use the “Transfer” option in the mobile application to transfer the configuration file to the network device. Another exemplary feature is that the network device does not need to be powered for the pre-configuration to occur.

In addition, by allowing the user to create a large number of unique configuration files for each IP address in a range, the user can pre-configure multiple network devices sitting in a warehouse before they are deployed without needing to power the network devices. Such functionality can be facilitated using GUIs of the application for example (For illustrations of the GUIs see FIGS. 5-7).

The application also allows the user to create a device inventory file (such as via the GUIs illustrated in FIGS. 4 and 6) by reading the MAC address, Serial number from the network device (e.g., switch) and associating it with the IP address and configuration file for future tracking and inventory management.

Diagnostics and configuration can be done via the low-power wireless communication interfaces (such via including the transceivers illustrated in FIGS. 1 and 2) of the network device and/or the end-user device. Once a network device is installed in a remote inaccessible location such as a light pole or high on a building wall, the field technician would need a scissor lift or a ladder to access the network device, connect his laptop via a console cable to the network device and perform diagnostics and changes to configuration while on the lift/ladder. The unique solution described herein eliminates the need for connecting a console cable to the network device to access it.

With the low-power communications solution (e.g., such as via BLE), the field technician can be in a truck or any convenient location within close proximity (e.g., 100 meters) of the network device and can securely access the network device through the application (such as via Mobile Application “troubleshoot” option illustrated in FIG. 3). This also provides network device diagnosis and configuration options such as reset the network device, set the IP address etc. (such as via the GUIs depicted in FIGS. 3-7). In addition, the low-power communication interface allows the technician access to the full command line interface on the network device through which the technician can view any status on the network device such as power status, e.g., Power-over-Ethernet (PoE) status, port status etc. or to configure any attribute on the network device.

Disclosed embodiments include applications, computing devices configured with the applications, and computer implemented methods to provide user interfaces on mobile computing devices to allow customers to configure, monitor, and diagnose network devices using NFC and low-power communications systems. For instance, user interfaces on mobile computing devices can allow customers to configure, monitor, and diagnose network devices using NFC, wherein the NFC is used at least in a setup phase to connect the network device to a network or the mobile device. Also, a low-power communications system can be combined with the NFC system to provide further setup and diagnosis functionality.

In one example embodiment, a network device (e.g., switch, a power-over-ethernet switch, etc.) can be configurable through an NFC channel such as without receiving power beyond power provided by the NFC channel. Such a network device can include a case (e.g., plastic case) or enclosure (e.g., a plastic enclosure with unique thermal management for example provided by a heat sink), configured to enclose the network device (such as shown in FIGS. 8, 9A and 9B). Also, the network device can include a processing unit that is configured to control and/or configure the network device when the network device is powered up. The network device can also include memory having network device configuration data and instructions executable by the processing unit to configure modules of the network device (such as switch, power-over-ethernet switch modules, etc.). The network device can also include a low-power wireless communication transceiver (e.g., BLE antenna, BLE antenna and corresponding control circuitry), configured to communicate with a corresponding transceiver of an end-user device (e.g., a mobile device such as a tablet or smart phone), and can also include an NFC transceiver (e.g., NFC antenna, NFC antenna and corresponding control circuitry), configured to, while the network device is powered down, communicate with a corresponding transceiver of an end-user device (e.g., a mobile device such as a tablet or smart phone). Such communications can occur through the case that encloses the network device. Also, the communications can include part of the network device configuration data being received by the NFC transceiver of the network device from the corresponding transceiver of the end-user device. Further, the NFC transceiver can include NFC memory that stores the part of the network device configuration data while the network device is powered down and the network device configuration data then can be used by the processing unit to configure the network device when the network device is powered up afterwards.

In such an embodiment, the end-user device (e.g., pc, mobile device such as tablet or smart phone) may include a processing unit and transceivers corresponding to the transceivers of the network device. For instance, the end-user device can include a low-power wireless communication transceiver (e.g., BLE antenna, BLE antenna and corresponding control circuitry), configured to communicate with a corresponding transceiver of the network device. Also, the end-user device can include an NFC transceiver (e.g., NFC antenna, NFC antenna and corresponding control circuitry), configured to communicate with a corresponding transceiver of the network device. The end-user device also includes memory and the memory can include network device configuration data and instructions to configure the network device. The memory of the end-user device can also include a network device configuration application executable by the processor. When executed, the application can facilitate configuring the network device by transmitting the network device configuration data and instructions to the network device via the low-power wireless communication transceiver or the NFC transceiver. Also, the application can monitor and diagnose the network device through an NFC channel and/or a low-power wireless channel (e.g., BLE channel) established by the respective transceivers of the end-user device and the network device. While the network device is powered down, the NFC transceiver can be configured to communicate with the corresponding transceiver of the network device, through the case of the network device. Also, the communications while the network device is powered down can include part of the network device configuration data being received by the corresponding transceiver of the network device from the NFC transceiver of the end-user device. Further, as mentioned, in such instances, the corresponding transceiver of the network device includes NFC memory that stores the part of the network device configuration data while the network device is powered down and the network device configuration data then is used by a processing unit of the network device to configure the network device when the network device is powered up.

### BRIEF DESCRIPTION OF THE DRAWINGS

FIG. 1 is a block diagram illustrating an example embodiment of a computing device (such as an end-user device) configured in accordance with exemplary embodiments.

FIG. 2 is a block diagram illustrating an example embodiment of a network device configured in accordance with exemplary embodiments.

FIGS. 3-7 are diagrammatic illustrations of GUI screens generated by an application running on the computing device of FIG. 1 configured in accordance with exemplary embodiments.

FIG. 8 is an exploded perspective view of an enclosure for a network device, with the enclosure having thermal management features in accordance with exemplary embodiments.

FIGS. 9A and 9B are end and bottom views of the enclosure shown in FIG. 8, with a heatsink having fins coupled, through the enclosure, to interior electronics to facilitate the use of wireless interfaces without requiring additional holes or apertures into the enclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Exemplary embodiments of the disclosed invention preferably include, and operate to configure, a computer such as a tablet computer, a mobile computing device such as a smart phone, a laptop computer, a desktop computer, or other computing devices, particularly computing devices having a touch screen input GUI. The exemplary embodiments include computer implemented methods, computer readable instructions, and configured computing devices which facilitate communication between an end-user device and/or a management system to configure a network device. The communication can include a wired and/or wireless communication to assist in the configuration of the network device. The wireless communication can include a NFC communication.

Although not required, disclosed embodiments are described in the general context of computer-executable instructions, such as program modules or applications, being executed by an electronic device such as a tablet computer or other computing device. Generally, program modules include routines, programs, objects, components, data structures, etc. that configure a processing unit or other computing device perform particular tasks. In embodiments, the disclosed embodiments may be practiced in distributed computing environments where tasks are performed by remote processing devices that are linked through a communications network. In a distributed computing environment, program modules may be located in both local and remote memory storage devices.

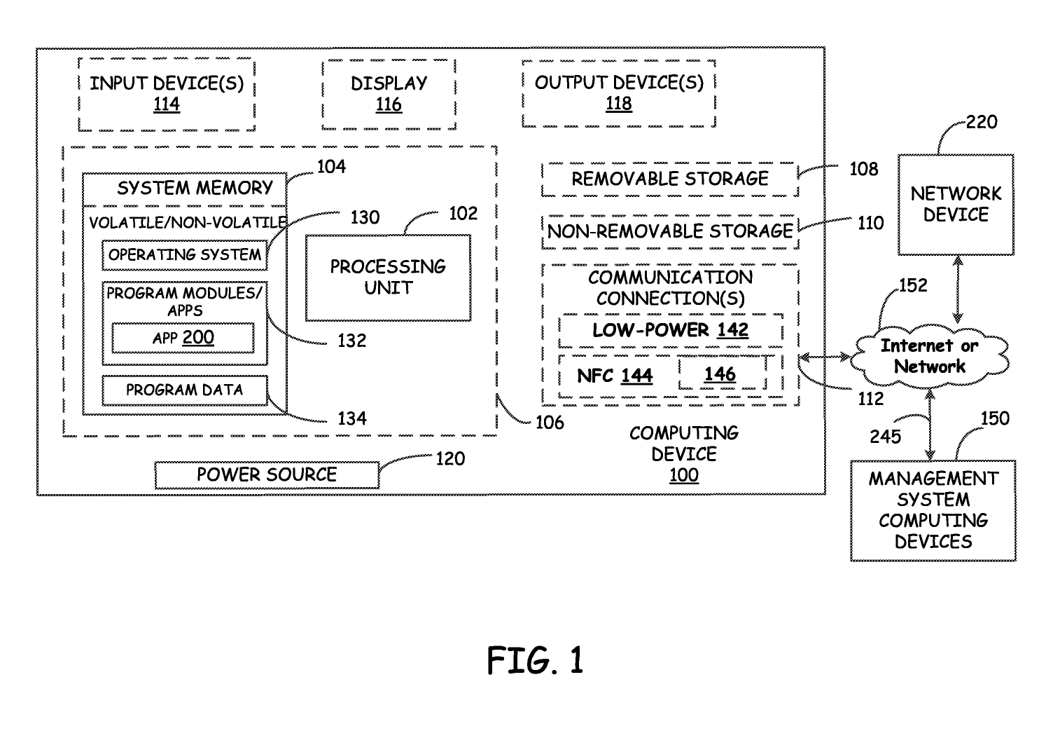

FIG. 1 shows an exemplary end-user computing device 100 for implementing exemplary disclosed embodiments. While in exemplary embodiments of end-user device 100 is a tablet type of computer or a mobile phone such as a smart phone, device 100 can be other types of computers and is therefore described in the context of a general computing device. In its most basic configuration, the end-user device 100 includes at least a processing unit 102 and a memory 104. Depending on the exact configuration and type of computing device, the memory 104 may be volatile (such as RAM), non-volatile (such as ROM, flash memory, etc.) or some combination of the two. This example configuration is illustrated in FIG. 1 by a dashed line 106.

Additionally, the device 100 may also have additional features/functionality. For example, the device 100 may also include additional storage (removable and/or non-removable) including, but not limited to, magnetic or optical disks or tapes, USB flash drives, memory cards, etc. Such additional storage is illustrated in FIG. 1 by a removable storage 108 and a non-removable storage 110. Computer storage media includes volatile and nonvolatile, removable and non-removable media implemented in any method or technology for storage of information such as computer readable instructions, data structures, program modules or other data. The memory 104, the removable storage 108 and the non-removable storage 110 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can be accessed by the device 100. Any such computer storage media may be part of the device 100.

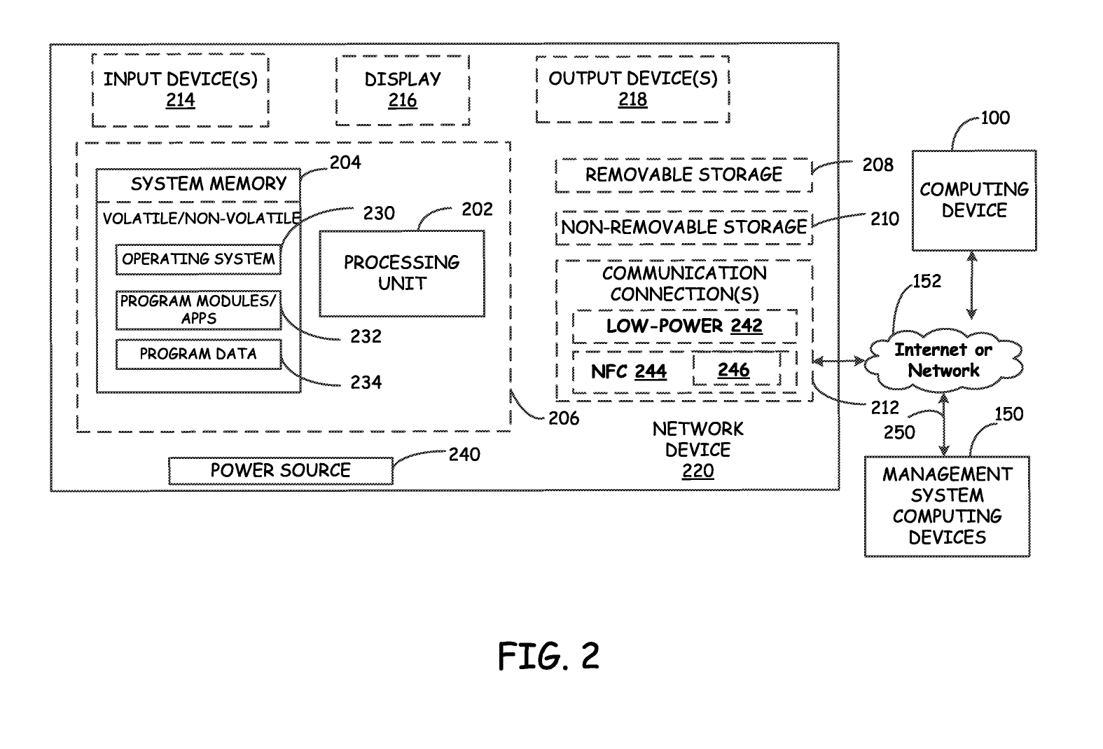

FIG. 2 shows an exemplary network device 220 for implementing exemplary disclosed embodiments. While in exemplary embodiments of the network device 220 is a switch, Power over Ethernet switch, or a self-enclosed switch, device 220 can be other types of network devices such as a modem, network hub, network router, bridge, repeater, etc. In its most basic configuration, the device 220 includes at least a processing unit 202 and a memory 204. Depending on the exact configuration and type of computing device, the memory 204 may be volatile (such as RAM), non-volatile (such as ROM, flash memory, etc.) or some combination of the two. This example configuration is illustrated in FIG. 2 by a dashed line 206.

Also, the device 220 may also have additional features/functionality. For example, the device 220 may include additional storage (removable and/or non-removable) including, but not limited to, magnetic or optical disks or tapes, USB flash drives, memory cards, etc. Such additional storage is illustrated in FIG. 2 by a removable storage 208 and a non-removable storage 210. Computer storage media includes volatile and nonvolatile, removable and non-removable media implemented in any method or technology for storage of information such as computer readable instructions, data structures, program modules or other data. The memory 204, the removable storage 208 and the non-removable storage 210 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can be accessed by the device 220. Any such computer storage media may be part of the device 220.

In the description that follows, disclosed embodiments will be described with reference to acts and symbolic representations of operations that are performed by one or more devices, unless indicated otherwise. As such, it will be understood that such acts and operations, which are at times referred to as being computer-executed, include the manipulation by the processing unit of the device of electrical signals representing data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while disclosed embodiments are described in the foregoing context, it is not meant to be limiting as those of skill in the art will appreciate that various of the acts and operations described hereinafter may also be implemented in hardware or firmware.

With device 100, system memory 104 may include operating system 130, one or more programming modules or applications 132, and program data 134. Operating system 130, for example, may be suitable for controlling end-user device 100's operation. As stated above, a number of program modules 132 and data files 134 may be stored in system memory 104, including operating system 130. While executing on processing unit 102, programming modules or applications 132 may perform processes including, for example, at least part of one or more methods described herein, such as by using one or more of the GUI screens or windows shown and described herein.

With device 220, system memory 204 may include operating system 230, one or more programming modules or applications 232, and program data 234. Operating system 130, for example, may be suitable for controlling device 220's operation. As stated above, a number of program modules 232 and data files 234 may be stored in system memory 204, including operating system 230. While executing on processing unit 202, programming modules or applications 232 may perform processes including, for example, at least part of one or more methods described herein, such as by using one or more of the GUI screens or windows shown and described herein.

Generally, consistent with disclosed embodiments, program modules or applications may include routines, programs, components, data structures, and other types of structures that may perform particular tasks or that may implement particular abstract data types. Moreover, disclosed embodiments may be practiced with other computer system configurations, including multiprocessor systems, microprocessor-based or programmable consumer electronics, minicomputers, mainframe computers, and the like. Disclosed embodiments may also be practiced in distributed computing environments where tasks are performed by remote processing devices that are linked through a communications network. In a distributed computing environment, program modules may be located in both local and remote memory storage devices.

Furthermore, some disclosed embodiments may be practiced in an electrical circuit including discrete electronic elements, packaged or integrated electronic chips containing logic gates, a circuit utilizing a microprocessor, or on a single chip containing electronic elements or microprocessors. Some disclosed embodiments may also be practiced using other technologies capable of performing logical operations such as, for example, AND, OR, and NOT, including but not limited to mechanical, optical, fluidic, and quantum technologies. In addition, some disclosed embodiments may be practiced within a general purpose computer or in any other circuits or systems.

Disclosed embodiments, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the disclosed embodiments may be embodied in hardware and/or in software (including firmware, resident software, micro-code, etc.). In other words, some disclosed embodiments may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain, store, communicate, propagate, or transport the program for use by or in connection with the instruction execution system, application, apparatus, or device.

The device 100 may also contain one or more communications connections 112 that allow the device to communicate with other devices. The communications connections 112 can include, for example, wired media connections such as a wired network or direct-wired connection, and wireless media connections such as acoustic, RF, infrared and other wireless media connections. In exemplary embodiments, communications connections 112 are configured to provide communication between end-user device 100 and a management system computing device 150, such as a management system server of the service provider, over a computer network 152 such as the Internet. Also, in exemplary embodiments, communications connections 112 are configured to provide communication between end-user device 100 and network device 220 (e.g., a switch, a PoE switch, router, modem, etc.), over a local communication channel such as low-power wireless communications channel by transceivers 242 and 142 (e.g., a BLE channel provided) and/or a NFC channel by transceivers 244 and 144.

The device 220 may also contain one or more communications connections 212 that allow the device to communicate with other devices. The communications connections 212 can include, for example, wired media connections such as a wired network or direct-wired connection, and wireless media connections such as acoustic, RF, infrared and other wireless media connections. In exemplary embodiments, communications connections 212 are configured to provide communication between device 220, end-user device 100, and a management system computing device 150, such as a management system server of the service provider, over a computer network 152 such as the Internet. Also, in exemplary embodiments, communications connections 212 are configured to provide communication between end-user device 100 and network device 220 (e.g., a switch, a PoE switch, router, modem, etc.), over a local communication channel such as low-power wireless communications channel by transceivers 242 and 142 (e.g., a BLE channel provided) and/or a NFC channel by transceivers 244 and 144.

Referring to FIGS. 1 and 2, the communications connections 112 can also provide communication with service provider networks or devices (such as network device 220) in some embodiments, for receiving services such as voice, video or data services. In exemplary embodiments, end-user device 100 is configured to provide GUI's which communicate with management system computing device 150 to manage, configure or change different parameters of services from the service provider. The management device 150 may include one or more computers including a management server. Connection to the computer network can include wireless communication, cellular data communication, and/or any other type of connection.

In some exemplary embodiments, communications with the management system computing device 150 can be enabled by communication circuitry of the device 150.

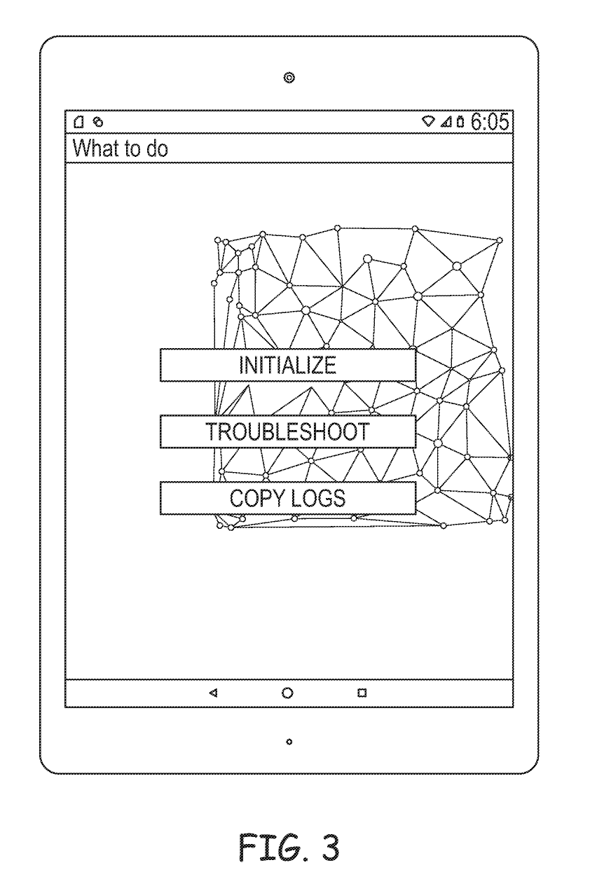

The communication circuitry of these devices of FIGS. 1-2 can be configured to communicate with end-user application 200 running on the end-user device 100. The end-user application 200 can include the GUIs of FIGS. 3-7, which can be configured to display on a screen of the end-user device. The GUIs of FIGS. 3-7 can also be configured to receive input indicative of a selected configuration of the network device 220 via at least one input field of the GUI.

In some exemplary embodiments in which either device 100 or 220 is a tablet computer or some sort of other mobile device or compact computing or networking system, instead of communication connections 112 or 212 connecting directly to Internet or network 152, communication connections 112 or 212 can include one or both of USB communication circuitry and wireless communication circuitry for communicating through network routers and other server computers which provide the connection to the Internet or other computer network 152.

In exemplary embodiments the end-user device 100 has, or can be coupled to, a touch screen display device 116 which provides a touch-based GUI. The device 100 may also have, or be coupled to, one or more input devices 114, such as a keyboard, mouse, pen, voice input device, etc., for providing other input to the computing device. The device 100 may be coupled to one or more other output devices 118 such as speakers, a printer, a vibration generator, etc. Further, display device 116, input devices 114 and output devices 118 can all be considered to be separate from, or alternatively part of, end-user device 100. Similar features may be provided by the network device 220 as well.

Also, end-user device 100 or network device 220 can be provided with a portable or non-portable power source 120 or 240, such as a battery pack, a transformer, a power supply, or the like. The power source 120 or 240 provides power for computations, communications and so forth by the device 100 or 220 respectively.

Referring to FIG. 1, shown is end-user device 100 having display device 116, for example a touch screen display device of a tablet computer, with the processing unit 102 of end-user device 100 configured with an exemplary end-user application 200 (of program modules/applications 132). End-user application 200 configures processing unit 102 to provide GUI's (e.g., GUIs of FIGS. 3-7) to allow a user such as a purchaser or end customer of services from a service provider to configure the network device 220 and/or other systems or devices, such as by using management system computing device 150 of the service provider, to control, diagnose and manage use of the network device 220. The similar features to the aforesaid features may also be provided by the network device 220.

End-user device 100 communicates with the device 150 using communications path or paths 245, which may include wireless based internet access, cellular data internet access, etc. Network device 220 communicates with the device 150 using communications path or paths 250, which may include wireless based internet access, cellular data internet access, etc. The network device 220 may include one or more switch device, for example. The device 100 or 220 may also provide access points for the customer's networks or devices to services provided by the service provider's networks or devices. For example, services provided by the service provider's networks or devices can include voice (e.g., VoIP), video and data service, among others.

The end-user application 200 can also communicate with management system computing device 150 via the management server's application program interface (API) to configure the Network device 220. Based on the values input into the end-user application 200 by the application user, the application determines the API calls to be made and the values to be configured on the network device 220. Device 150 can communicate with the network device 220 via communication connection 250. Once the configuration is complete, the application can update the GUI to show the new configurations. The application can show a graphical view of the services available and related parameters. The changes made to the configuration can be stored on memory (such as flash memory) on the network device 220. The changes in configuration can be made almost instantaneously without taking down the service. Or, the changes can be initiated with a complete power down of the network device 220, via NFC communications powered by the end-user device 100. This allows for the user to partially configure the network device 220 without the network device being powered up. Example GUIs supported the aforesaid features are illustrated in FIGS. 3-7.

In short, the disclosed embodiments herein include a mobile computing device application which configures a mobile computing device to provide a simple, intuitive user interface, and provide the ability to at least initiate configuring and diagnosing a network device without powering up the network device.

In an exemplary embodiment, the end-user device 100 may be a mobile device such as tablet or smart phone. The mobile device 100 may include a housing that is plastic. The end-user device may also include power circuitry such as power source 120.

The end-user device 100 may also include a low-power wireless communication transceiver 142, configured to communicate with a corresponding transceiver of a network device (such as network device 220) or another end-user device. The end-user device 100 may also include an NFC transceiver 144, configured to communicate with a corresponding transceiver of a network device (such as network device 220) or another end-user device.

When the network device 220 is a PoE switch for example, the end-user device 100 may also include memory (such as memory 104), comprising network device configuration data (which may be part of program data 134) and instructions to configure a PoE data communications module and a PoE power module of a PoE switch. The end-user device 100 may also include a low-power wireless communication module, configured to control low-power wireless communications. The end-user device 100 may also include an NFC module, configured to control NFC wireless communications and including NFC memory 146.

Not depicted, the device 100 may also include a bus, configured to communicatively couple the power circuitry, the processor, the memory, and the transceivers of the device 100.

The memory 104 may also comprise a network device configuration application, which may be application 200. For exemplary GUIs of the network device configuration application see FIGS. 3-7. The application may be stored in the memory and executable by the processing unit 102 to configure, monitor, and/or diagnosis issues of the network device 220 through an NFC channel and/or a low-power wireless channel (e.g., BLE channel). In some instances, the application may be executable to communicate with the network device over a low-power wireless channel and establish a session via command line interface. The application may also be executable to send a command to the network device to restart or to set an Internet Protocol address.

The application may also be executable to connect to the network device over an NFC channel so as to be able to write to the NFC memory 246 of the network device without the network device being powered on or at least not receiving power from the power cable. The application may also be executable to connect to the network device over an NFC channel so as to be able establish a communication channel to the device with the network device being powered on or at least powered through the power cable. The application may also be executable to transfer a file to the NFC memory 246 of the network device. The application may also be executable to read the MAC address and serial number from the NFC memory 246. All such features may occur without the network device being powered on since NFC can be used.

Referring to FIG. 2, in an exemplary embodiment, the network device 220 (which may be a switch, a PoE switch, a self-enclosed PoE switch, etc.) can be configurable without receiving power over a power cable. Where the device 220 is a PoE switch, it can be adapted to couple to the power cable and the data cable and can be configurable without receiving power over the power cable.

The network device 220 may also include a case (e.g., plastic case), configured to enclose the network device. In instances of a plastic case, such an arrangement facilitates partial configuration via NFC because NFC signals can travel effectively through plastic.

The network device 220 may also include power circuitry (such as a power source 240), configured to receive power from the power cable and power the network device 220.

The network device 220 may also include a processing unit 202, configured to read and write data and instructions communicated over the data cable and/or stored in memory 204 of the network device 220. The processing unit 202 can also be configured to control and/or configure the network device 220.

In some embodiments, where the network device 220 is a PoE switch, the network device 220 may also include memory comprising a PoE data communications module and a PoE power management module. In such instances, the network device configuration data and instructions may be executable by the processing unit 202 to configure the PoE data communications module and the PoE power module. The network device 220 may also include a low-power wireless communication module (e.g., BLE module, etc.) configured to control low-power wireless communications. The device 220 may also include a near-field communication (NFC) module configured to control NFC wireless communications and including NFC memory 246.

The network device 220 may also include a low-power wireless communication transceiver 242 (e.g., BLE antenna, BLE antenna and corresponding control circuitry), configured to communicate with a corresponding transceiver of an end-user device (e.g., a mobile device such as a tablet or smart phone). The network device 220 may also include an NFC transceiver 244 (e.g., NFC antenna, NFC antenna and corresponding control circuitry), configured to communicate with an NFC transceiver of an end-user device (e.g., a mobile device such as a tablet or smart phone). Wherein the network device 220 is an Ethernet switch it may also include an Ethernet transceiver, configured to enable the network device to communicate with other network devices via the data communications cable.

The network device 220 may also include a bus (not depicted), coupling the power circuitry, the processor, the memory, and the transceivers of the network device.

In some embodiments, the network device 220 has, or can be coupled to, a touch screen display device 216 which provides a touch-based GUI. The device 220 may also have, or be coupled to, one or more input devices 214, such as a keyboard, mouse, pen, voice input device, etc., for providing other input to the computing device. The device 220 may be coupled to one or more other output devices 218 such as speakers, a printer, a vibration generator, etc. Further, display device 216, input devices 214 and output devices 218 can all be considered to be separate from, or alternatively part of, device 220.

### Example Use Case 1

Referring back to the network device configuration application (which may be application 200), in one exemplary embodiment, the application can be configured to facilitate NFC communications when the end-user device 100 and the network device 220 are positioned proximate to each other (e.g., 4 centimeters from each other) such that the end-user device 100 configures the network device via an NFC channel. If the NFC connection is not established, the application can prompt the user to move the devices closer. After successful transfer of the configuration file, the application can also be configured to associate a network device configuration file name of the network device configuration file that was pushed to the network device from the end-user device using an IP address from a device inventory table stored in the memory of the end-user device. The application can also be configured to start a network device configuration session for a range of IP addresses of network devices including the network device and prompt the user with the next available IP address and associated configuration file, so as to make the configuration of a large number of devices easy and ensure no accidental duplication of IP addresses.

### Example Use Case 2

In another exemplary embodiment, the application can be configured to create an inventory data file such that the application can read serial number, IP address and MAC addresses from the network device 220, wherein the application can associate the serial number and MAC address to the IP address that is stored in the device inventory table. The application can also be configured to transfer the network device inventory table to another end-user device such as a remote PC, such that configurations of the network device can occur from the PC.

### Example Use Case 3

In another exemplary embodiment, the application can be configured to create a configuration file on a remote PC using a GUI of the application which may originate from the memory of the network device. The application can also be configured to import the network device configuration file from the PC and transfer to the network device as part of Use Case 1.

### Example Use Case 4

In another exemplary embodiment, the application can be used over a lower-power wireless connection (e.g., BLE connection) as a replacement for the console cable, such as an alternative to using PC connector cable that may be used in the Example Use Cases 1, 2, and 3. In such a use case, the application may also provide an interface for field technician to install a configuration file for the network device, by connecting to the network device through the lower-power wireless connection, and setting IP address or verifying IP address if already set, and checking port status and power status (such as PoE status) on all ports connected to network devices (such as PoE devices) before leaving installation site.

When remote management to the network device is lost and device can no longer be managed from a network operation center or a central computing system such as the management system computing device 150, the application can be used to configure the network device via BLE or another wireless communication protocol preferably of lower-power type. For instance, a field technician goes to site where device is mounted on a pole or otherwise inaccessible and connects to device via a lower-power wireless connection from the truck without having to connect to the device via a console cable. Then, the field technician can perform diagnostics over the command line interface or reset the device.

The features described herein that may be implemented via a GUI can be implemented via the GUIs depicted FIGS. 3-7.

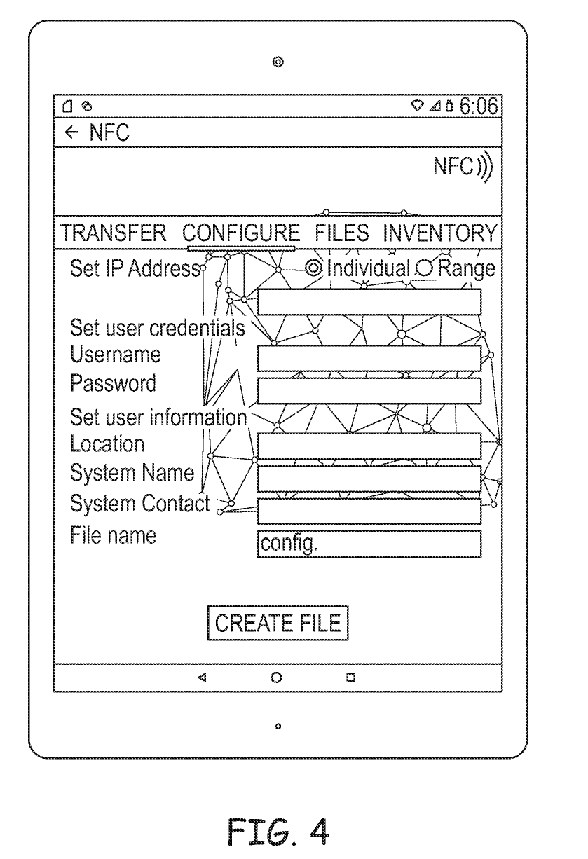

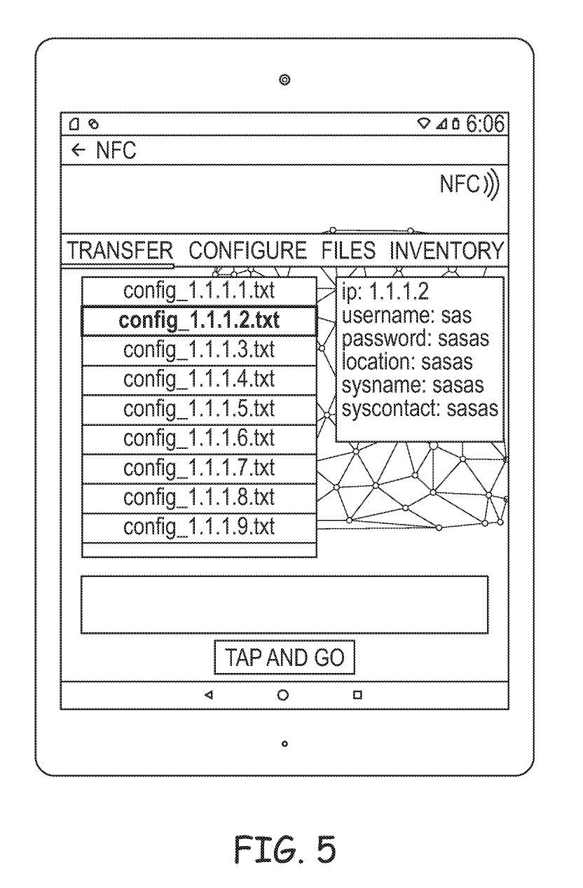

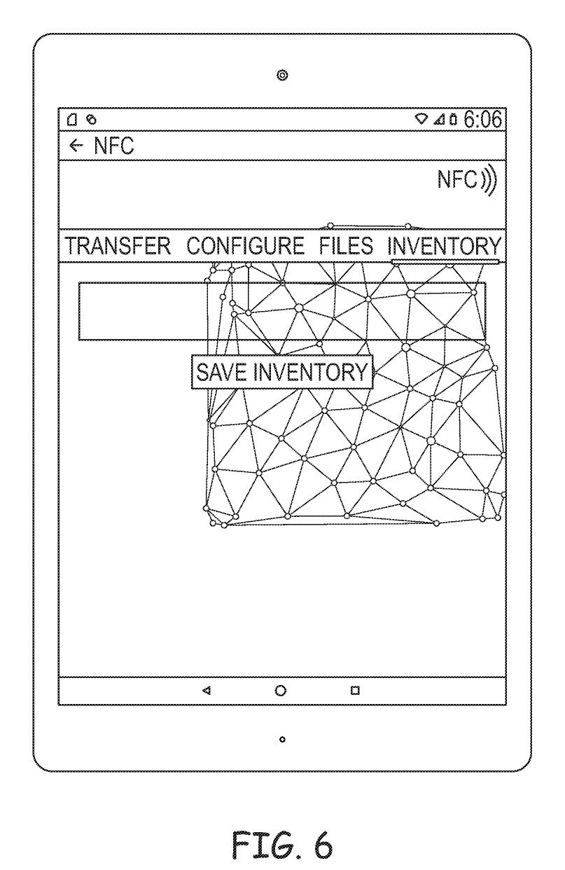

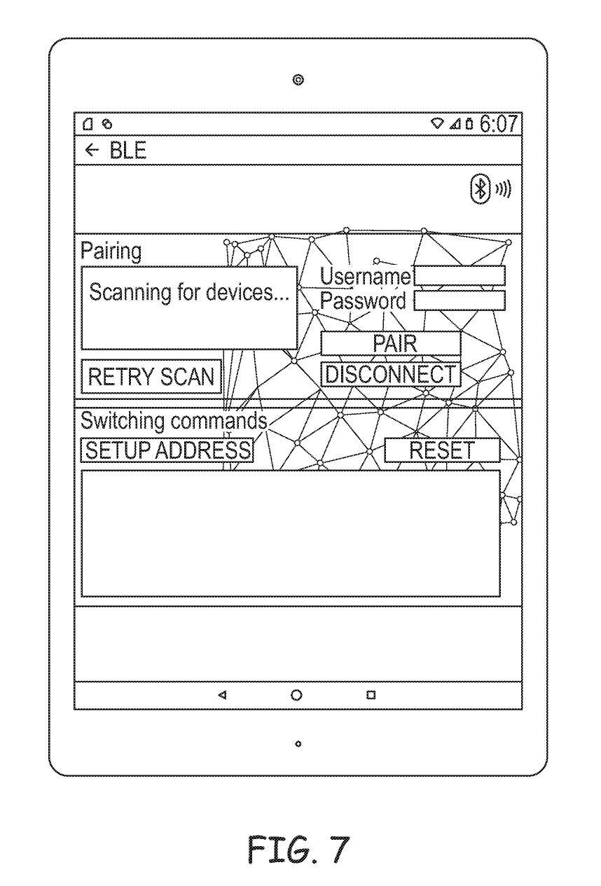

Referring to FIG. 3, depicted is an “initialize” button in an example initial screen that can link a user to another screen depicted in FIG. 4. Also, in the initial screen a user can select the “troubleshoot” button which can take the user to the screen depicted in FIG. 7. In the initial screen a user can also select the “copy logs” button which can take the user to the screen depicted in FIG. 5 or 6.

Referring to FIG. 4, a user can, such as via a NFC channel, set an IP address via the IP address element, or set a range of IP addresses, such as via the set IP address range element. For instance, the range of multiple IP addresses can be set via auto-increment, or individually via manual selection, etc. Also, a user can set user credentials (username and password) such as via respective elements of the screen. A user can also transfer configured files via the transfer configure files inventory element. Also, user information such as location and system name, contact information, and time of input and output information associated with a user or system can be reviewed or set by the screen in FIG. 4. Also, information regarding configuration files can be accessed via the file name element and such files can be created by the create file element of the screen for example.

Referring to FIGS. 5 and 6, a user can, such as via a NFC channel, transfer a configuration files inventory, select an individual confirmation file such as from the list of available configuration files that can be stored on the end-user device or a network device, and perform other related tasks that require very little power such as power can be provided through an NFC channel. Other functionality accessible through the screens can include file management, import and export of such files, and removal of the files from the system. Information in the files can include device MAC address, serial number, and IP address, and such parameters can be configured via the screens. Also, such parameters and files can be updated, added, and managed via NFC and/or low-power wireless communication channels via the screens. Also, a selected configuration file (such as from list of available configuration files on mobile device) can be provided. A quick select feature can also be provided in the “Tap and Go” button.

Referring to FIG. 7, depicted is a screen provided by the application that includes a pairing GUI element. The screen also includes scanning for devices GUI element. To access the respective paring of device and scanning of device functionality, the screen also provides user authentication elements. Also, elements for resetting a paired device or multiple network devices is provided. And, for more advance configuration and monitoring functionality a command line element is provided (such as the shown switch command line element). Also, the screen shows pair/disconnect elements, and a reset element that in cases of the user providing a range of IP addresses, the IP address will be auto-incremented and multiple configuration files will be generated each with a unique IP address in the range provided by the user. Also, the access to the command line on the network device can give the user access to the commands supported by the device allowing for troubleshooting. Other advanced features can include providing basic level of diagnostic information on port status, power status (such PoE status) such as in a table or some graphical view. In addition, users can run a network device debugger and tester from the application. Another advanced feature can include a drop-down menu with network device operating system commands.

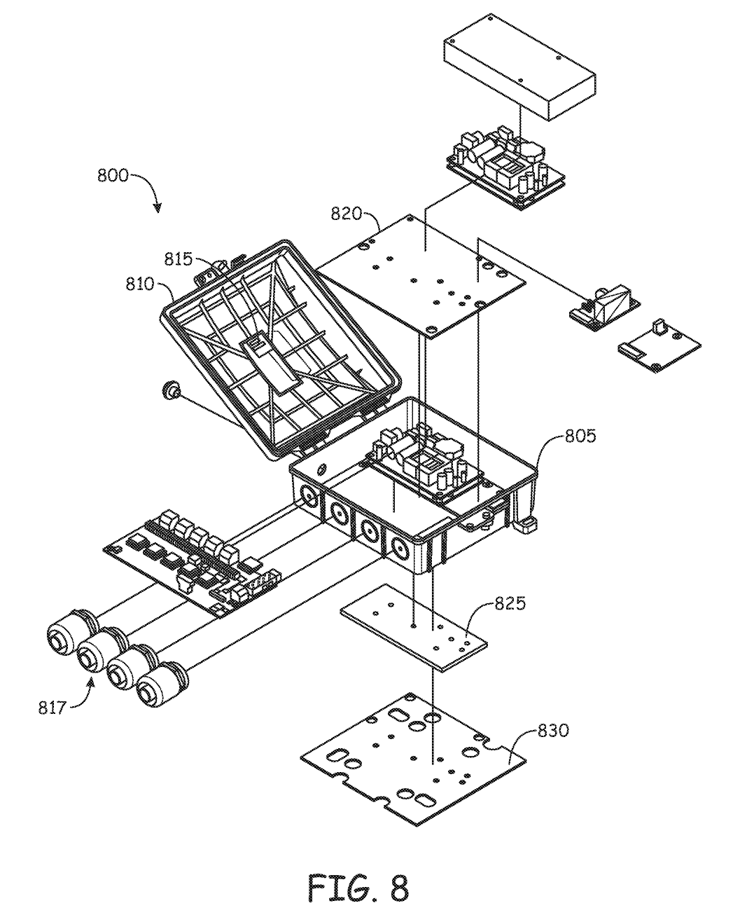

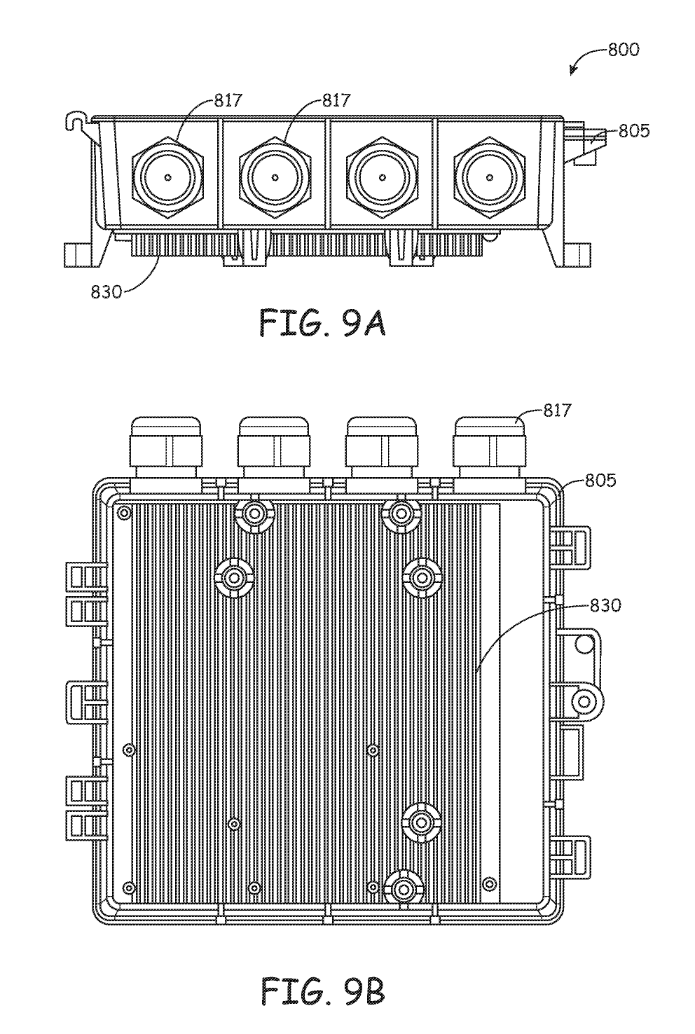

Referring now to FIGS. 8, 9A and 9B, shown is an exemplary embodiment of an enclosure which can be used to facilitate the use of wireless technology as described, without requiring additional holes or apertures for access to external antennas. The enclosure or case 800 includes an enclosure base 805 and an enclosure lid 810, which can both be formed from plastic or similar material which will not block wireless signals received or transmitted through one or more wireless antennas, such as wireless antennal 815.

Plastic enclosures are themselves typically poor dissipaters of heat. However, enclosure 800 includes unique heat dissipation configurations and features that allow the product to be compliant with the IEEE 802.3bt 90 Watt Power Over Ethernet standard. As such, a device housed in enclosure 800 can simultaneously supply four ports 817 with 60 Watts of PoE power each, for a total of 240 Watts. Or up to 90 Watts on any port as long as the total power doesn't exceed 240 Watts. This system which is roughly 90% efficient, requires that nearly 30 Watts of power must be removed from the enclosure to prevent the components from overheating. To manage that much heat rejection, enclosure 800 utilizes an external heat radiator to the enclosure with a heat conductive path to the interior of the enclosure. There are no cooling holes or fans in this device, all heat is removed by conduction then radiated outside the enclosure by the external heatsink. It is the use of a plastic enclosure that enables the ease of use wireless interfaces without the need for additional holes and more complex external antennas such as ferrite backed NFC antennas as compared to an enclosure made of metal that would have required external antennas.

FIG. 8 illustrates an inner mounting plate 820 on which electronic components, modules or circuit boards can be mounted. This plate collects the heat from the components in the enclosure that are thermally coupled to it through thermo-conductive pads. From there the heat flows through the enclosure via the conductive bar 825, which can be aluminum for example. From the bar 825 the heat is then dissipated externally to outer heatsink plate 830 coupled to the base 805 of the enclosure. As shown in FIGS. 9A and 9B, heatsink plate 830 can be an extruded metal heat sink with a series of fins to aid in heat dissipation. All of the thermo elements have their efficiency enhanced by using thermo-conductive pads or alternatives such as thermo grease to conduct heat energy to mounting plate 820.

With reference to the disclosure herein, although the present invention has been described with reference to preferred embodiments, workers skilled in the art will recognize that changes may be made in form and detail without departing from the spirit and scope of the invention. While BLE and NFC are specifically discussed, other similar protocols and technologies can be used instead. For instance, while BLE is described, other low energy radio protocols in the ISM band can be used, such as Zigbee, low power WIFI, Lora, to name a few. Also, other radio standards exist that can be used in the cellular LTE space.

What is claimed is:

1. An end-user device, comprising:
a processing unit;
transceiver circuitry configured to communicate wirelessly with corresponding transceiver circuitry of a network device;
memory, comprising:
network device configuration data and instructions to configure the network device;
a network device configuration application executable by the processing unit to:
facilitate configuring the network device by transmitting the network device configuration data and instructions to the network device using the transceiver circuitry; and
monitor and diagnose the network device through a communications channel established by the transceiver circuitry of the end-user device and the transceiver circuitry of the network device.

2. The end user device of claim 1, wherein the end user device is a mobile computing device having a touchscreen display, the network device configuration application configuring the processing unit of the end user device to provide a graphical user interface on the touchscreen display to facilitate configuring the network device through the communication channel.

3. The end user device of claim 2, wherein the transceiver circuitry further comprises a low-power wireless communication transceiver configured to communicate with a corresponding low-power wireless communication transceiver of the network device.

4. The end user device of claim 3, wherein the transceiver circuitry further comprises a near-field communication (NFC) transceiver configured to communicate with a corresponding NFC transceiver of the network device.

5. The end user device of claim 4,
wherein, while the network device is powered down, the NFC transceiver of the end user device is configured to communicate with the NFC transceiver of the network device, through a case of the network device,
wherein the communications while the network device is powered down include transmitting part of the network device configuration data from the NFC transceiver and to the NFC transceiver of the network device.

6. The end user device of claim 5,
wherein the NFC transceiver of the network device comprises NFC memory that stores the part of the network device configuration data while the network device is powered down and the network device configuration data then is used by a processing unit of the network device to configure the network device when the network device is powered up.

7. The end user device of claim 5, wherein the network device configuration application configures the processing unit of the end user device to provide the graphical user interface to monitor and diagnose the network device using a low-power communications channel between the low-power wireless communication transceiver of the end user device and the low-power wireless communication transceiver of the network device.

8. The end user device of claim 7, wherein the low-power wireless communications transceiver is a Bluetooth Low Energy (BLE) transceiver.

9. A network device configurable through a near-field communication (NFC) channel without receiving power beyond power provided by the NFC channel, comprising:
a case configured to enclose the network device;
a processing unit configured to control and/or configure the network device when the network device is powered up;
memory, comprising:
network device configuration data and instructions executable by the processing unit to configure modules of the network device;
a low-power wireless communication transceiver configured to communicate with a corresponding low-power wireless communication transceiver of an end-user mobile device; and
a near-field communication (NFC) transceiver configured to, while the network device is powered down, wirelessly communicate with a corresponding NFC transceiver of the end-user mobile device through the case,
the communications between the NFC transceivers including part of the network device configuration data being received by the NFC transceiver of the network device from the corresponding NFC transceiver of the end-user mobile device;
the NFC transceiver comprising NFC memory that stores the part of the network device configuration data while the network device is powered down, and
the network device configuration data then is used by the processing unit to configure the network device when the network device is powered up.

10. The network device of claim 9, wherein after the network device is powered up, the processing unit is configured to control the low-power wireless communication transceiver to communicate with the corresponding low-power wireless communication transceiver of the end-user mobile device to allow the end-user mobile device to monitor and diagnose the network device.

11. The network device of claim 9, wherein the network device is a switch.

12. The network device of claim 11, wherein the network device is a Power-over-Ethernet (PoE) switch.

13. The network device of claim 9, wherein the low-power wireless communication transceiver is a is a Bluetooth Low Energy (BLE) transceiver.

14. The network device of claim 9, wherein the case is a plastic enclosure allowing low-power wireless and NFC communication therethrough without antennas external to the plastic enclosure.

15. The network device of claim 14, and further comprising an outer heat sink positioned outside of the plastic enclosure and thermally coupled to electrical components within the plastic enclosure.

16. The network device of claim 15, where the network device enclosed within the plastic enclosure is configured to supply at least 240 Watts of power.

17. The network device of claim 15, wherein the network device enclosed within the plastic enclosure is a Power-over-Ethernet (PoE) switch configured to simultaneously supply four ports with at least 60 Watts of PoE power each.

18. The network device of claim 17, wherein the network device enclosed within the plastic enclosure is further configured to supply any one of the four ports with up to 90 Watts of PoE power as long as total power supplied to the four ports does not exceed a predetermined threshold amount of power.

19. The network device of claim 18, wherein the network device further comprises an inner mounting plate, positioned interior to the plastic enclosure, on which the electrical components are mounted, the inner mounting plate being thermally coupled to the outer heat sink to conduct heat from the electrical components to the outer heat sink for dissipation outside of the plastic enclosure.
